(19) United States
(12) Patent Application Publication
(10) Pub. No.: US 2026/0154502 A1
(43) Pub. Date: Jun. 4, 2026

(54) METHOD AND SYSTEM FOR PERFORMING PLURALITY OF NATURAL LANGUAGE PROCESSING TASKS IN TEXT CORPUS

(71) Applicants: KING FAHD UNIVERSITY OF PETROLEUM AND MINERALS, Dhahran (SA); SAUDI DATA AND ARTIFICIAL INTELLIGENCE AUTHORITY (SDAIA), Riyadh (SA)

(72) Inventors: Irfan AHMAD, Dhahran (SA); Maged S. AL-SHAIBANI, Dhahran (SA)

(73) Assignees: KING FAHD UNIVERSITY OF PETROLEUM AND MINERALS, Dhahran (SA); SAUDI DATA AND ARTIFICIAL INTELLIGENCE AUTHORITY (SDAIA), Riyadh (SA)

(21) Appl. No.: 18/967,823

(22) Filed: Dec. 4, 2024

(51) Int. Cl. G06F 40/284

(52) U.S. Cl. CPC G06F 40/284

(57) ABSTRACT

A method and a system for performing natural language processing tasks in a text corpus includes removing all vowels from a block of words in the text corpus to obtain a reduced text corpus having reduced vocabulary. The method trains a plurality of causal language models including a statistical model, a recurrent neural network (RNN)-based model, and a transformer-based models with a training portion of the reduced text corpus. The method trains a plurality of natural language processing task models. The trained models can be used for a user-selected operation, including language modeling, text classification, sequence labeling, and translation tasks. The method provides text processing through vocabulary reduction while maintaining task performance. The reduced text representation decreases computational requirements while preserving linguistic information for natural language processing applications.

### STATEMENT OF PRIOR DISCLOSURE Y AN INVENTOR(S)

Aspects of the present disclosure are described in Maged Al-shaibani and Irfan Ahmad, “Consonant is all you need: a compact representation of English text for efficient NLP,” Findings of the Association for Computational Linguistics: EMNLP 2023, pages 11578-11588, which is incorporated herein by reference in its entirety.

### STATEMENT OF ACKNOWLEDGEMENT

Support provided by King Fahd University of Petroleum and Minerals (KFUPM) and the Saudi Data and AI Authority (SDAIA) through SDAIA-KFUPM Joint Research Center for Artificial Intelligence grant number JRC-AI-RFP-06 is gratefully acknowledged.

### BACKGROUND

### Technical Field

The present disclosure relates to the field of natural language processing (NLP), and more particularly to methods and systems for efficient text representation in NLP tasks utilizing masked-vowel and consonant-only techniques to reduce vocabulary size while maintaining performance.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Natural language processing (NLP) tasks like text classification, sequence labeling, and translation rely heavily on text representation and processing of large text corpora. In NLP, text representation and tokenization play important roles in various tasks such as language modeling, sentiment analysis, machine translation, and other applications. Traditional approaches to text representation maintain the complete text including both consonants and vowels, mirroring human reading and writing patterns. These approaches utilize various language models including statistical models, recurrent neural network (RNN)-based models, and transformer-based models to process and analyze text for different NLP applications. However, processing complete text representations with both consonants and vowels leads to large vocabulary sizes and increased computational requirements. The large vocabulary results in bigger embedding layers and higher model complexity, which, in turn, increases memory usage, computational costs, and training times for NLP models. Further, word-based embedding layers have high potential to suffer from overfitting. Additionally, out-of-vocabulary (OOV) words pose challenges when processing text with complete character representations.

To address this issue, regularization techniques like embedding dropout can be applied [See: Gal Y, Ghahramani Z (2016) A theoretically grounded application of dropout in recurrent neural networks]. Techniques such as dimensionality reduction [See: Raunak V, Gupta V, Metze F (2019) Effective dimensionality reduction for word embeddings], quantization [See: Gholami A, Kim S, Dong Z, Yao Z, Mahoney M W, Keutzer K (2021) A survey of quantization methods for efficient neural network inference], and distillation networks [See: Hinton G, Vinyals O, Dean J (2015) Distilling the knowledge in a neural network] can also be used. Although these methods are effective in addressing embedding overfitting, they do not address vocabulary reduction before embedding.

Statistical methods like bag-of-words and TF-IDF have also been employed to handle vocabulary-related challenges. These methods are effective in modeling word relations but are limited by OOV problems, particularly in natural language generation tasks. Further, these approaches significantly degrade in their ability to represent words with large sparse embeddings. Additionally, they face vocabulary explosion challenges, where numerous vocabulary items with few occurrences need to be embedded, following Zipf's law [See: Zipf G K (2016) Human behavior and the principle of least effort: An introduction to human ecology]. Dense-embedding representations, such as Word2Vec [See: Mikolov T, Chen K, Corrado G, Dean J (2013) Efficient estimation of word representations in vector space], have been proposed to overcome limitations of sparse embeddings, but those too have their limitations.

Other approaches use character-level processing as alternatives to full word-based processing. Character-based approaches result in very small vocabulary size and resolve OOV issues. However, they produce longer sequences, which can introduce vanishing and exploding gradients in sequence modeling [See: Bengio Y, Simard P, Frasconi P (1994) Learning long-term dependencies with gradient descent is difficult]. Character-level approaches incorporated into CNN layers before RNN processing have shown good results [See: Zhang X, Zhao J, LeCun Y (2015) Character-level convolutional networks for text classification]. This character-level approach has also been implemented in transformer architectures [See: Ma W, Cui Y, Si C, Liu T, Wang S, Hu G (2020) CharBERT: Character-aware pre-trained language model]. However, character-based approaches are known to generate meaningless new words.

Subword tokenization techniques provide a trade-off between characters and words as tokens. These methods divide words into character chunks called subwords, with various techniques proposed for optimal splitting. The primary goal is representing text with smaller vocabulary size without compromising performance. Both language-specific and data-driven methods exist [See: Zaid Alyafeai, Maged S Al-shaibani, Mustafa Ghaleb, and Irfan Ahmad. 2022. Evaluating various tokenizers for arabic text classification. Neural Processing Letters, pages 1-23; Mielke S J, Alyafeai Z, Salesky E, Raffel C, Dey M, Galé M, Raja A, Si C, Lee W Y, Sagot B, et al. (2021) Between words and characters: A brief history of open-vocabulary modeling and tokenization in NLP]. Data-driven approaches are common in recent language models, such as BERT [See: Devlin J, Chang M W, Lee K, Toutanova K (2019) BERT: Pre-training of deep bidirectional transformers for language understanding] and GPT [See: Brown T, Mann B, Ryder N, Subbiah M, Kaplan J D, Dhariwal P, Neelakantan A, Shyam P, Sastry G, Askell A, et al. (2020) Language models are few-shot learners], and other large models. Examples of these methods include SentencePiece [See: Kudo T, Richardson J (2018) SentencePiece: A simple and language independent subword tokenizer and detokenizer for neural text processing], WordPiece [See: Song X, Salcianu A, Song Y, Dopson D, Zhou D (2021) Fast wordpiece tokenization], and UnigramLM [See: Kudo T (2018) Subword regularization: Improving neural network translation models with multiple subword candidates]. Most of these methods build on Byte-Pair-Encoding (BPE) data compression techniques [See: Gage P (1994) A new algorithm for data compression]. However, existing subword approaches may still result in larger than necessary vocabulary sizes and computational requirements.

Visual representation approaches have also been explored [See: Mansimov E, Stern M, Chen M, Firat O, Uszkoreit J, Jain P (2020) Towards end-to-end in-image neural machine translation; Salesky E, Etter D, Post M (2021) Robust open-vocabulary translation from visual text representations]. While showing promise for handling noise and spelling variations, these techniques have not yet demonstrated competitive performance and are not widely adopted compared to traditional text representations.

Accordingly, it is one object of the present disclosure to provide improved systems and methods for efficient text representation in NLP that can reduce vocabulary size and computational requirements while maintaining task performance. The present disclosure addresses the need for a compact text representation scheme that enables efficient NLP processing without sacrificing the ability to recover original text when needed for human readability.

### SUMMARY

In an exemplary embodiment, a computer-implemented method of performing natural language processing in a text corpus is described, comprising: receiving, by a processor, a block of words in the text corpus; removing all vowels from the block of words with the processor to obtain a reduced text corpus having a reduced vocabulary; training a plurality of causal language models including a statistical model, a recurrent neural network (RNN)-based model, and a transformer-based models with a training portion of the reduced text corpus to obtain a plurality of respective working causal language models; receiving, by the processing circuitry, a plurality of task-specific language data in the text corpus; removing all vowels from each of the task-specific language data with the processor to obtain respective reduced task-specific language data; training a plurality of natural language processing task models with the respective task data to obtain a plurality of working language processing task models; selecting a natural language processing task; selecting causal language modeling or a natural language processing task, each having a respective one of the plurality of the working causal language models or the plurality of working natural language processing task models; and performing the selected causal language modeling or the selected natural language processing task using the respective working causal language model or working natural language processing task model with the processor.

In some embodiments, the plurality of natural language processing tasks is selected from the group consisting of a language modeling task, a text classification task, a sequence labeling task, and a translation task.

In some embodiments, the statistical model is a n-gram language model, wherein the n-gram language model is selected from the group consisting of 2-gram language model, 3-gram language model, 4-gram language model, 5-gram language model, and 6-gram language model.

In some embodiments, the working natural language processing task model is a RNN-based model when the selected task is the text classification task, wherein the text classification task comprises a binary sentiment analysis, and wherein the performing the selected task further comprises categorizing the block of words into one of two subcategories.

In some embodiments, the working natural language processing task model is a RNN-based model when selected task is the sequence labeling task, and wherein the performing the selected task further comprises assigning a label to a sequence of tokens in the block of words to obtain a labeled sequence of tokens.

In some embodiments, the working natural language processing task model is a transformer-based model when the selected task is the translation task, and wherein the performing the selected task further comprises: tokenizing each reduced text in the reduced texts corpus; and translating the reduced texts corpus in a first language to a second language to obtain a translated texts corpus.

In some embodiments, the removing all vowels from the block of words comprises: parsing the block of words in the text corpus to identify one or more vowels in the plurality of texts; and replacing the one or more vowels with a mask-symbol, wherein the mask-symbol corresponds to each vowel of the one or more vowels. wherein a total number of each word in the block of words is preserved.

In some embodiments, the step of removing all vowels includes replacing each vowel with the mask-symbol that is a single character including a “#”.

In some embodiments, the method further comprises: retrieving the block of words from the reduced text corpus using the RNN language model, wherein the RNN language model consists of two layers of bidirectional LSTM each having 512 hidden units and an embedding layer with a dropout of 0.25 to obtain a retrieved text corpus; and performing a post-processing including a spelling correction and a grammar correction to refine the retrieved text corpus.

In another exemplary embodiment, a system for performing natural language processing in a text corpus is described, comprising: an input device configured to obtain a user-selected causal language modeling or a natural language processing task; a processor comprising a graphics processing unit (GPU) and connected to the input device; and a memory connected to the processor; wherein the processor is configured to execute program instructions, comprising: vowel vocabulary reducing in a text corpus by removing all vowels from a block of words in the text corpus to obtain a reduced text corpus having a reduced vocabulary; training a plurality of causal language models including a statistical model, a recurrent neural network (RNN)-based model, and a transformer-based model with a training portion of the reduced text corpus to obtain a plurality of respective language models; receiving a plurality of task-specific language data in the text corpus corresponding to a plurality of natural language processing tasks; removing all vowels from each of the task-specific language data to obtain respective reduced task-specific language data; training a plurality of natural language processing task models with the respective task data to obtain a plurality of working natural language processing task models; selecting one of the plurality of causal language models or the plurality of natural language processing task models based on the user-selected natural language processing task and performing the selected causal language modeling or the selected natural language processing task using the respective working causal language model or working natural language processing task model.

In some embodiments, the plurality of natural language processing tasks is selected from the group consisting of a language modeling task, a text classification task, a sequence labeling task, and a translation task.

In some embodiments, the statistical model is a n-gram language model, wherein the n-gram language model is selected from the group consisting of 2-gram language model, 3-gram language model, 4-gram language model, 5-gram language model, and 6-gram language model.

In some embodiments, the working natural language modeling task model is a RNN-based model when the selected task is the text classification task, wherein the text classification task comprises a binary sentiment analysis, and wherein the performing the selected task further comprises categorizing the block of words into one of two subcategories.

In some embodiments, the working natural language processing task model is a RNN-based model when the user-selected task is the sequence labeling task, and wherein the performing the user-selected task further comprises assigning a label to a sequence of tokens in the block of words to obtain a labeled sequence of tokens.

In some embodiments, the working natural language processing task model is a transformer-based model when the user-selected task is the translation task, and wherein the performing the user-selected task further comprises: tokenizing each reduced text in the reduced texts corpus; and translating the reduced texts corpus in a first language to a second language to obtain a translated texts corpus.

In some embodiments, the removing all vowels from the block of words comprises: parsing the block of words in the text corpus to identify one or more vowels in the block of words; and replacing the one or more vowels with a mask-symbol, wherein the mask-symbol corresponds to each vowel of the one or more vowels. wherein a total number of each word in the block of words is preserved.

In some embodiments, the mask-symbol is a single character including a “#”.

In some embodiments, the system further comprises: retrieving the block of words from the reduced text corpus using the RNN language model, wherein the RNN language model consists of two layers of bidirectional LSTM each having 512 hidden units and an embedding layer with a dropout of 0.25 to obtain a retrieved text corpus; and performing a post-processing including a spelling correction and a grammar correction to refine the retrieved text corpus.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary flowchart of a method of performing a plurality of natural language processing tasks in a text corpus having a plurality of texts with a processor, according to certain embodiments.

FIG. 2 is an exemplary schematic diagram of a system for performing a plurality of natural language processing tasks in a text corpus having a plurality of texts, according to certain embodiments.

FIG. 3 is an illustration of a non-limiting example of details of a controller used in a processor, according to certain embodiments.

FIG. 4 is an exemplary schematic diagram of a data processing system used within the processor, according to certain embodiments.

FIG. 5 is an exemplary schematic diagram of the processor, according to certain embodiments.

FIG. 6 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to methods and systems for language modeling and performing natural language processing tasks in a text corpus using vowel removal and masked-vowel vocabulary reduction techniques. The systems and methods provide approaches for processing text data while reducing vocabulary size and computational requirements, applicable across various natural language processing tasks including text classification, sequence labeling, and translation. The present disclosure introduces techniques for representing text using either completely removing vowels or masked vowels, where vowels in text are replaced with a mask symbol while maintaining word structure and count. This representation enables reduced vocabulary size while preserving sufficient information for natural language processing tasks. The present disclosure further provides ability to retrieve original text representation when human readability is required. Through integration of statistical models, recurrent neural networks, and transformer-based architectures, the present disclosure enables efficient processing of text data while maintaining performance levels comparable to standard text representation approaches. The methods and systems of the present disclosure are particularly applicable in scenarios requiring efficient text processing with limited computational resources, while ensuring ability to reconstruct original text when needed.

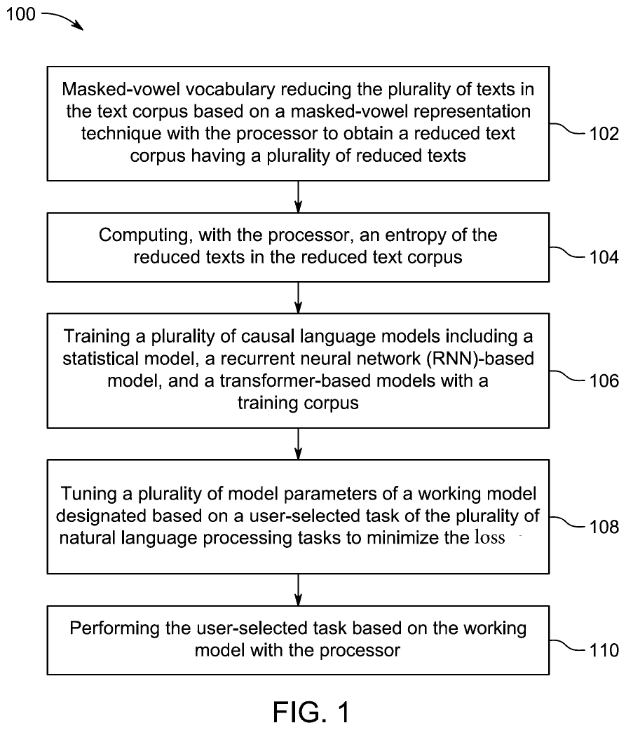

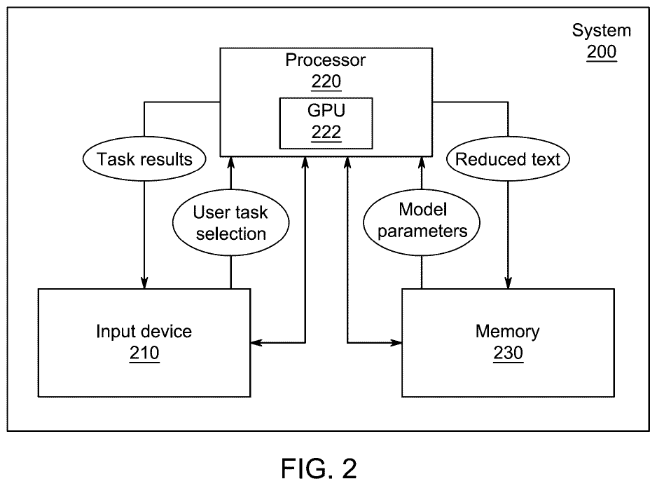

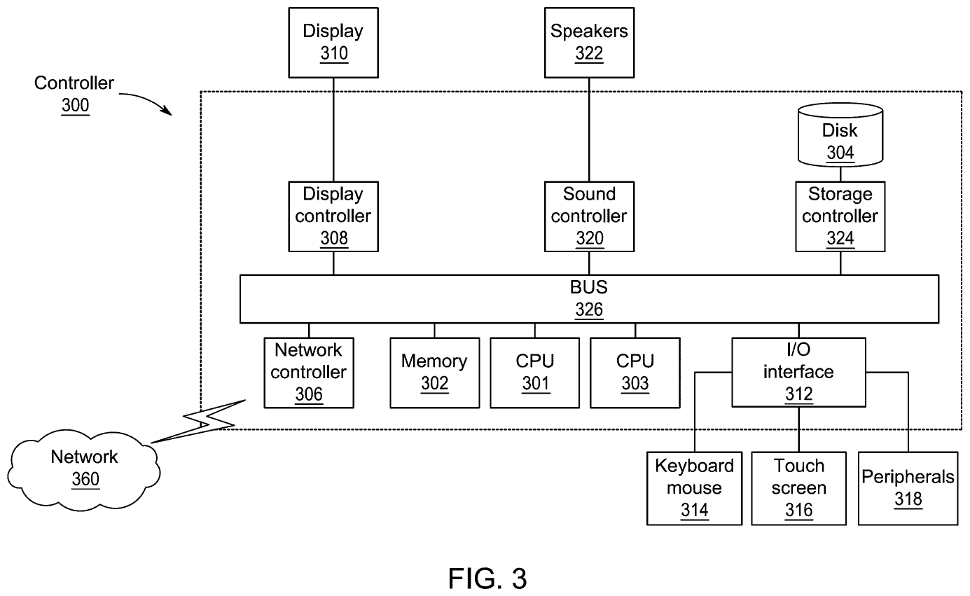

Referring to FIG. 1, illustrated is a flowchart of a method (as represented by reference numeral 100) for performing a plurality of natural language processing tasks in a text corpus having a plurality of texts with a processor. The details about the processor, as utilized by the method 100, are discussed later in the description with reference to FIG. 2 and in more details in FIGS. 3-6. The method 100 implements a systematic approach to process text data using masked-vowel representation for various NLP applications. The method 100 addresses fundamental challenges in natural language processing related to vocabulary size management, embedding layer dimensions, computational resource requirements, and out-of-vocabulary word handling. The method 100 of the present disclosure integrates masked-vowel representation with established language modeling approaches, which 100 enables efficient text processing while maintaining performance levels comparable to standard text processing approaches.

For the purposes of the present disclosure, the text corpus may include various types of textual data suitable for NLP tasks such as text classification, sequence labeling, or translation. The text corpus preserves original formatting and characters to maintain authenticity of language usage patterns. The input data retains punctuation marks, special characters, and text in multiple languages where present, enabling processing of real-world language variations. The text corpus serves as the foundation for subsequent processing steps, including masked-vowel vocabulary reduction and natural language processing operations, while maintaining the inherent structure and characteristics of the source texts.

At step 102, the method 100 includes masked-vowel vocabulary reducing the plurality of texts in the text corpus based on a consonant-only or masked-vowel representation technique with the processor to obtain a reduced text corpus having a plurality of reduced texts. Herein, the processor executes the masked-vowel vocabulary reduction on the plurality of texts. The masked-vowel vocabulary reduction implements the masked-vowel representation technique that processes the plurality of texts to identify vowels within the texts, removes and replaces each identified vowel with a mask symbol. The mask symbol comprises a single character, such as “#”, that serves as a placeholder for the vowel being masked. The masked-vowel representation technique preserves the total number of words in the plurality of texts while reducing the vocabulary size by mapping multiple vowel variations to a single mask symbol.

The mask-vowel representation technique comprises multiple steps executed by the processor to transform standard text into a reduced representation. The technique maintains strict rules for processing text while preserving essential structural characteristics of the input corpus. In the present implementation, the mask-vowel representation technique comprises parsing the plurality of texts in the text corpus to identify one or more vowels in the plurality of texts. During parsing, the processor systematically examines each character in the text corpus to locate vowel characters. The processor identifies both uppercase and lowercase instances of the vowels “A”, “E”, “I”, “O”, and “U”. The parsing process maintains the sequential order of the text while creating a mapping of vowel positions within each word and sentence structure. The mask-vowel representation technique further includes removing and replacing the one or more vowels with a mask-symbol, wherein the mask-symbol corresponds to each vowel of the one or more vowels. After identifying vowel positions, the processor removes and replaces each vowel with a predetermined mask-symbol. The replacement operation maintains the position and spacing of the original text while substituting vowels with the mask-symbol. For example, processing the word “HELLO” results in “H#LL#”, where each vowel “E” and “O” is replaced with the mask-symbol. Herein, a total number of each word in the plurality of texts is preserved. This preservation ensures that the reduced text maintains the same word count and positioning as the original text corpus. The processor maintains word boundaries, spacing, and sequential order during vowel replacement. This preservation is particularly important for natural language processing tasks that rely on word sequence and position information, such as part-of-speech tagging and named entity recognition.

Herein, the mask-symbol is a single character including a “#”. The processor consistently uses the “#” character as the standard mask-symbol for all vowel replacements. Using a single character as the mask-symbol ensures uniform text length reduction while maintaining clear identification of vowel positions. The “#” character is selected as it is distinct from standard text characters and easily identifiable in the reduced text representation. For example, when processing the sentence “The quick brown fox jumps over the lazy dog”, the processor generates the reduced text “Th# q##ck br#wn f#x j#mps #v#r th# l#zy d#g”. This transformation demonstrates how the technique preserves word count and structure while replacing all vowels with the “#” mask-symbol. The reduced representation maintains readability and structural information while decreasing vocabulary size through vowel masking.

The present disclosure provides an alternative of consonant-based representations for English text. The alternative representation involves removing all vowel letters (A, E, I, O, and U), regardless of their case, from the text, resulting in a consonants-only representation. This approach may exclude complete words that consist solely of vowels, such as the determiner ‘A’ and pronoun ‘I’. However, such vowel-only words are typically rare in English. It is worth noting that certain NLP tasks require preserving the total number of words in the input sequence in the output sequence, as is the case with sequence labeling tasks such as POS tagging. For these tasks, this representation may be less suitable. Thus, the present disclosure can use the representation where all vowels are masked with the symbol ‘#’ used as placeholder(s) for vowel only words. Below is an example illustration of the two representations compared to the standard English text. The first line is the standard English text. The second line represents the consonants-only representation. The third line represents the masked-vowels representation.
Standing on the shoulders of giants
   Stndng n th shldrs f gnts
St#nd#ng #n th# sh##ld#rs #f g##nts

The processor applies either the consonants-only representation or the masked-vowel representation technique uniformly across the entire text corpus to generate the reduced text corpus. The reduced text corpus maintains semantic relationships between words while requiring fewer unique tokens to represent the text content. This allows language models and natural language processing task models to achieve comparable performance metrics while operating on a smaller vocabulary. Additionally, the preservation of word count and positioning enables sequence-dependent tasks like part-of-speech tagging to function effectively with the reduced texts. It may be noted that the masked-vowel vocabulary reduction, as per embodiments of the present disclosure, achieves a significant decrease in vocabulary size compared to standard text representation. The reduction in vocabulary size directly correlates to decreased memory requirements for storing the text corpus and reduced computational overhead when processing the texts for natural language processing tasks.

At step 104, the method 100 includes computing, with the processor, an entropy of the reduced texts in the reduced text corpus. The entropy computation provides a measure of information content and predictability in the reduced text representation. The processor performs word-level entropy computation by analyzing the frequency and distribution of unique word tokens in the reduced texts. At the character level, the processor computes entropy by evaluating the frequency and positioning of individual characters, including the mask symbol, within the reduced texts. The processor utilizes the computed entropy metrics to evaluate the effectiveness of the masked-vowel representation technique. Lower entropy values indicate that the reduced texts maintain predictable patterns while requiring fewer unique tokens for representation. This entropy reduction directly impacts the training and optimization of language models by providing more structured input with reduced variability. Such entropy computation provides quantitative metrics for assessing information preservation in the reduced text corpus. The processor can use the entropy calculations to compare different text representation approaches and validate the efficiency of the masked-vowel technique.

In the present examples, the entropy computation implements Shannon entropy calculations at both word level and character level within the reduced texts. The entropy H is calculated using the formula:

$$H ( t ) = {\sum }_{t}^{T} - P ( t ) {log}_{2} P ( t ) \qquad ( 1 )$$

where t represents a token from the set of T vocabulary in a given text, and P(t) is the probability of occurrence of token t. This entropy calculation helps in understanding the information preservation characteristics of the masked-vowel representation.

Testing demonstrates that the masked-vowel representation exhibits lower word-level entropy compared to standard text representation. The decreased word entropy indicates reduced uncertainty in word prediction tasks, which correlates with the smaller vocabulary size achieved through vowel masking. Specifically, character-level entropy calculations demonstrate that the masked-vowel representation achieves the lowest entropy among tested text representations. This reduced character entropy results from the deterministic pattern of consonants typically being followed by one or two mask symbols representing vowels within words. The predictable positioning of mask symbols decreases uncertainty in character sequence prediction, which can be advantageous in certain NLP applications.

At step 106, the method 100 includes training different types of causal language models including a statistical model, a recurrent neural network (RNN)-based model, and a transformer-based models with a training corpus. The training implements these distinct model types to process the consonant-only representation or masked-vowel text representation. As used herein, the “the causal language models” refers to a collection of different types of computational models designed to process and analyze text by predicting subsequent elements (words, characters, or tokens) based on preceding elements in a sequence. This specifically encompasses three distinct types of models: statistical models, recurrent neural network (RNN)-based models, and transformer-based models, each implementing different approaches for processing masked-vowel text representations. The training of the causal language models refers to the process of optimizing model parameters using a training corpus to enable accurate prediction and processing of text sequences. The training process involves presenting text sequences to each model type, computing prediction errors, and adjusting model parameters to minimize these errors. For statistical models, this involves computing probability distributions of token sequences. For neural network-based models, this involves updating network weights through backpropagation using specified loss functions and optimization algorithms. In an implementation, the training corpus used for these models is the Wikitext-2 benchmark [See: Merity Stephen, Xiong Caiming, Bradbury James, and Richard Socher. 2017. Pointer sentinel mixture models. Proceedings of ICLR, incorporated herein by reference in its entirety].

In present embodiments, the statistical model is a n-gram language model. The n-gram language model implementation analyzes fixed-length sequences of consecutive tokens (n-grams) to compute probability distributions of token occurrences. The n-gram language model is selected from a defined group of implementations comprising 2-gram language model, 3-gram language model, 4-gram language model, 5-gram language model, and 6-gram language model. In an example, the statistical model utilizes the KenLM toolkit [See: Kenneth Heafield. 2011. Kenlm: Faster and smaller language model queries. In Proceedings of the sixth workshop on statistical machine translation, pages 187-197, incorporated herein by reference in its entirety] with modified Kneser-Ney smoothing technique [See: Kenneth Heafield, Ivan Pouzyrevsky, Jonathan H Clark, and Philipp Koehn. 2013. Scalable modified Kneser-Ney language model estimation. In Proceedings of the 51st Annual Meeting of the Association for Computational Linguistics (Volume 2: Short Papers), pages 690-696, incorporated herein by reference in its entirety] to process text sequences ranging from 2 to 6 tokens in length, maintaining default hyperparameter settings throughout implementation. The statistical model processes sequences of ‘n’ consecutive tokens from the reduced text corpus to learn probability distributions of token sequences. Herein, the 2-gram language model processes pairs of consecutive tokens in the reduced text corpus. The processor implements the 2-gram model as a baseline for comparing performance improvements with larger n-gram configurations. The 3-gram language model analyzes sequences of three consecutive tokens to learn text patterns. The processor utilizes the 3-gram model to capture additional context compared to the 2-gram implementation. The 4-gram language model processes four-token sequences from the reduced text corpus. The 4-gram model provides enhanced pattern recognition through extended sequence analysis. The 5-gram language model evaluates five-token sequences to model text patterns. The processor implements the 5-gram model to capture longer-range dependencies in the text. The 6-gram language model analyzes sequences of six consecutive tokens. The 6-gram implementation represents the largest context window evaluated in the statistical modeling approach, and has the best perplexity scores.

Also, as used herein, the RNN-based model refers to a neural network architecture that processes sequential data using recurrent connections and memory states. The RNN-based model comprises an embedding layer, multiple long short-term memory (LSTM) layers with specified hidden units, dropout layers for regularization, and dense layers for prediction. The model implements cross-entropy loss with softmax activation and utilizes Adam optimization with specified learning rate schedules. In a preferred embodiment of the RNN-based language models, a network architecture includes an embedding layer, followed by a dropout layer set to 0.333 [See: Gal Y and Ghahramani Z (2016) A theoretically grounded application of dropout in recurrent neural networks. Advances in neural information processing systems, 29, incorporated herein by reference in its entirety]. The dropout layer is followed by 4 LSTM layers, each with 512 hidden units, and another dropout layer. The outputs is activated by a ReLU activation function and passed to a dense layer for prediction. The system utilizes cross-entropy with softmax activation as the loss function and employes the Adam optimizer for network optimization. The initial learning rate is set to 0.001 and decayed by half when there is no improvement for an entire epoch. Training is performed for 100 epochs, and early stopping is implemented when there is no improvement in the validation loss for 5 consecutive epochs. Additionally, output and embedding tying techniques are employed [See: Press O and Wolf L (2017) Using the output embedding to improve language models. Proceedings of the 15th Conference of the European Chapter of the Association for Computational Linguistics: Volume 2, Short Papers, pages 157-163; Inan H, Khosravi K, and Socher R. Tying word vectors and word classifiers: A loss framework for language modeling. International Conference on Learning Representations, incorporated herein by reference in their entirety].

Further, as used herein, the transformer-based models with a training corpus refers to neural network architectures that process text using self-attention mechanisms and positional encodings, trained on a specified text corpus. The transformer-based model implements decoder layers with multiple attention heads, feed-forward networks of specified size, and dropout regularization. The model utilizes stochastic gradient descent (SGD) optimization with specified decay factors and gradient clipping for training stability. In a preferred embodiment of the transformer-based language model, an architecture includes two decoder layers implemented with two attention heads with dropout of 0.2. The feed-forward network size is set to 200. The optimizer uses SGD with a decay factor of 0.25 if the validation loss does not improve for 1 epoch. The training stoppes if there is no improvement for 5 consecutive epochs. To overcome potential gradient explosion, gradient norms are clipped to 0.25.

In present implementations, for the RNN-based and the transformer-based models, two tokenization schemes are implemented: word-based tokenization, as well as subwords tokenization using BPE implementation from [See: Kudo T and Richardson J (2018), incorporated herein by reference in its entirety].

At step 108, the method 100 includes training model parameters of a working model designated based on a user-selected task of the various types of natural language processing tasks. The working model is preferably a RNN or transformer-based architecture depending on the specific requirements of each natural language processing task. The processor executes parameter tuning operations on a working model that is designated according to the specific user-selected task from the various types of natural language processing tasks. The processor implements an iterative training approach that systematically adjusts model parameters based on a loss function. In example implementations, the loss function is the cross-entropy loss. The tuning process incorporates early stopping criteria to prevent overfitting to the reduced text representation. In present implementations, the processor maintains separate parameter configurations for each text representation format—standard text, consonants-only, and masked-vowel representations. This enables optimal performance for each representation while allowing comparative analysis of parameter sensitivity across different text formats. Testing demonstrates that the masked-vowel representation typically requires fewer tuning iterations to achieve optimal performance due to its reduced entropy characteristics.

The present disclosure further involves processing these representations by comparing their performance with standard English text across various language models and NLP tasks, employing different settings and configurations. These tasks include binary and multiclass text classification, POS tagging, NER and NMT. Language modeling serves as an upstream task for many downstream tasks such as spell correction, automatic speech recognition (ASR), machine translation, and optical character recognition (OCR). Therefore, the performance of the causal language models are evaluated. Additionally, POS tagging and NER are examples of sequence labeling tasks, where the output has the same length as the input. It may be emphasized that, in order to ensure a fair comparison, the disclosed models are tuned to achieve the best results for standard text. In an embodiment, the consonant-only and masked vowel models may be tuned to optimize the performance for the proposed representations to yield improved results compared to standard text.

In embodiments of the present disclosure, one of the various types of natural language processing tasks is selected from the group consisting of a text classification task, a sequence labeling task, and a translation task. The text classification task includes an automated process of analyzing text input to assign predefined categorical labels. The text classification task includes two distinct operations: binary sentiment analysis which assigns one of two possible sentiment categories to input text, and multiclass text classification which assigns one of multiple possible topic categories to input text. For implementing the text classification task, the input text undergoes preprocessing to remove HTTP links, HTML tags, numbers, punctuation marks, emojis, and non-ASCII characters, followed by stopword removal and word lemmatization using the NLTK toolkit. The sequence labeling task includes an automated process where each token in an input text sequence receives a corresponding label, maintaining identical sequence length between input and output. The sequence labeling task processes text sequences token by token, assigning labels based on the linguistic role or entity type of each token. The sequence labeling task specifically preserves the total count and sequential ordering of tokens while performing the labeling operation, making this task distinctive from classification tasks that generate single labels for entire text segments. The translation task includes an automated process of converting text from a first language to a second language while maintaining semantic meaning. The translation task implements word-based tokenization and handles unknown tokens by removing single-occurrence tokens from the target sequence. The translation task specifically processes parallel text data where corresponding text segments in two different languages are aligned to enable learning of translation patterns. The translation task generates output text in the target language with length and structure that may differ from the input text, distinguishing it from sequence labeling tasks that maintain fixed sequence lengths.

At step 110, the method 100 includes performing the user-selected task based on the working model with the processor. The processor executes the user-selected task utilizing the designated working model that has been trained for the specific task requirements. The performing of the user-selected task implements different processing approaches based on whether the task involves text classification, sequence labeling, or translation operations. During task execution, the processor monitors and records performance metrics specific to each task type. The processor further implements specific data handling procedures during task execution. The processor, then, generates task outputs in formats appropriate for the selected task type.

According to an embodiment of the present disclosure, the working model is a RNN network, in particular a bidirectional LSTM model when the user-selected task is the text classification task. The bidirectional LSTM model processes sequences of n consecutive tokens to perform classification operations on the reduced texts. As used herein, the binary sentiment analysis refers to a text classification task that processes text input to categorize the text into one of two sentiment categories. The binary sentiment analysis utilizes a dataset comprising text reviews that are classified as either positive sentiment or negative sentiment. The binary sentiment analysis employs binary cross entropy loss with sigmoid activation to generate classification outputs. The multiclass text classification refers to a text classification task that processes text input to categorize the text into one of multiple predefined categories exceeding two classes. The multiclass classification employs cross entropy loss with softmax activation to generate classification outputs across the multiple categories. Both binary sentiment analysis and multiclass text classification apply consistent preprocessing steps including removal of HTTP links, HTML tags, numbers, punctuation marks, emojis, and non-ASCII characters, followed by stopword removal and lemmatization using the NLTK toolkit [See: Edward Loper and Steven Bird. 2002. Nltk: the natural language toolkit. In Proceedings of the ACL-02 Workshop on Effective tools and methodologies for teaching natural language processing and computational linguistics—Volume 1, pages 63-70, incorporated herein by reference in its entirety].

In the present embodiment, the performing of the user-selected task further includes categorizing the reduced texts into subcategories. For binary sentiment analysis, the processor categorizes texts into positive and negative sentiment subcategories. For multiclass classification, the processor assigns texts to appropriate news category subcategories. The categorization process analyzes sequences in the reduced texts to identify patterns indicative of specific subcategories. The processor generates probability distributions across possible subcategories and assigns classifications based on highest probability scores. The bidirectional LSTM model maintains separate parameter configurations for processing standard text, consonants-only, and masked-vowel representations. Testing demonstrates that reduced text representations achieve comparable classification performance while requiring fewer computational resources due to reduced vocabulary size.

In an exemplary implementation, the binary sentiment analysis is used to process the IMDB reviews dataset [See: Andrew L. Maas, Raymond E. Daly, Peter T. Pham, Dan Huang, Andrew Y. Ng, and Christopher Potts. 2011. Learning word vectors for sentiment analysis. In Proceedings of the 49th Annual Meeting of the Association for Computational Linguistics: Human Language Technologies, pages 142-150, Portland, Oregon, USA. Association for Computational Linguistics, incorporated herein by reference in its entirety] containing 25,000 training samples and 25,000 testing samples, with 10% of training samples allocated for validation. The binary sentiment analysis implements binary cross entropy loss with sigmoid activation to classify texts into positive or negative sentiment categories.

In another exemplary implementation, the multiclass text classification utilizes the AGNews benchmark dataset [See: Xiang Zhang, Junbo Zhao, and Yann LeCun. 2015. Character-level convolutional networks for text classification. In Advances in Neural Information Processing Systems, volume 28. Curran Associates, Inc., incorporated herein by reference in its entirety] to classify text into four distinct news categories. This benchmark consists of four news classes, with 120,000 samples for training and 7,600 samples for testing. Similar to the IMDB dataset, 10% of the training set is reserved for validation. The multiclass text classification implements the same neural network architecture as binary sentiment analysis, comprising 4 bidirectional LSTM layers with 256 hidden units each and embedding layers of size 512, with dropout rates of 0.4 for embeddings and 0.333 for LSTM layers. The multiclass classification employs cross entropy loss with softmax activation to generate classification outputs across the multiple categories.

According to another embodiment of the present disclosure, the working model is the RNN-based model similar to that used for text classification when the user-selected task is the sequence labeling task. Sequence labeling is a category of tasks where the input is a sequence of tokens, and the output is another sequence of tokens with the same length. These tasks, also known as token classification tasks, involve assigning a label to each token in the input sequence. In the present embodiment, the performing of the user-selected task further includes assigning a label to a sequence of tokens in the reduced texts corpus to obtain a labeled sequence of tokens. The RNN-based model processes input sequences bidirectionally to consider both forward and backward context when assigning labels. The processor generates label predictions for each token position while maintaining sequence length preservation between input and output. For masked-vowel representation, the processor ensures mask symbols retain appropriate token boundaries during label assignment. The consonants-only representation requires additional handling for cases where vowel-only words are removed from the sequence. The sequence labeling implementation utilizes task-specific output layers sized according to the number of possible labels for each task. The processor applies softmax activation to generate probability distributions across possible labels for each token position. Label assignments are determined based on highest probability scores while maintaining sequence constraints specific to each labeling task.

In an example implementation, the RNN-based model utilizes a 4-layer bidirectional LSTM architecture with 256 hidden units and embedding layers of size 512, as in the text classification, with the exception of a embedding dropout, which is set to 0.5. In the present examples, two types of sequence labeling tasks are considered, including part-of-speech (POS) tagging and named entity recognition (NER). For POS tagging, the processor assigns labels from the Universal Dependencies project [See: Joakim Nivre, Marie-Catherine de Marneffe, Filip Ginter, Jan Hajic, Christopher D. Manning, Sampo ̌ Pyysalo, Sebastian Schuster, Francis Tyers, and Daniel Zeman. 2020. Universal Dependencies v2: An evergrowing multilingual treebank collection. In Proceedings of the Twelfth Language Resources and Evaluation Conference, pages 4034-4043, Marseille, France. European Language Resources Association, incorporated herein by reference in its entirety] comprising 17 distinct tags to each token in the English Web Treebank dataset, which contains 254,825 words across 16,621 sentences. The processor maintains one-to-one correspondence between input tokens and assigned POS tags. For named entity recognition (NER), the processor assigns entity labels to tokens using the CoNLLpp dataset [See: Erik F. Tjong Kim Sang and Fien De Meulder. 2003. Introduction to the CoNLL—2003 shared task: Language-independent named entity recognition. In Proceedings of the Seventh Conference on Natural Language Learning at HLT-NAACL 2003, pages 142-147, incorporated herein by reference in its entirety], which was corrected by [See: Zihan Wang, Jingbo Shang, Liyuan Liu, Lihao Lu, Jiacheng Liu, and Jiawei Han. 2019. Crossweigh: Training named entity tagger from imperfect annotations. In Proceedings of the 2019 Conference on Empirical Methods in Natural Language Processing and the 9th International Joint Conference on Natural Language Processing (EMNLP-IJCNLP), pages 5157-5166, incorporated herein by reference in its entirety] and referred to as CoNLLpp. The CoNLLpp dataset consists of a total of 20,744 samples, with 14,041 samples allocated for training, 3,250 samples for validation, and 3,453 samples for testing. The dataset contains a total of 301,418 words. In this dataset, there are 9 different named entities. As mentioned above, the model configuration used for training on the CoNLLpp dataset is similar to the one implemented for the text classification task, with the exception of the embedding dropout, which is set to 0.5. Additionally, the output size of the model is equal to the number of classes specific to each task.

According to yet another embodiment of the present disclosure, the working model is a transformer-based model when the user-selected task is the translation task. The processor implements a transformer-based model as the working model when executing translation tasks on the reduced text corpus. The transformer-based model includes one encoder layer and one decoder layer with 8 multi-head attention mechanisms, utilizing 2048 latent dimensions and 256 embedding size for processing text translations. Herein, the performing the user-selected task further includes tokenizing each reduced text of the reduced texts in the reduced texts corpus. The processor implements word-based tokenization for processing the reduced texts. During tokenization, the processor removes tokens that occur only once in the target sequence to manage unknown tokens. The tokenization process maintains consistency with the masked-vowel or consonants-only representation format while preparing text sequences for translation. In the present embodiment, the performing of the user-selected task further comprises translating the plurality of reduced texts in the reduced texts corpus in a first language to a second language to obtain a translated texts corpus. The transformer-based model maintains separate parameter configurations for processing different text representations. The translation process preserves the reduced text format throughout processing until final output generation.

In an example implementation, the processor executes bidirectional translation between English and German languages. The tokenization method used is word-based tokenization. To model the unknown tokens, the tokens that occur only once are removed from the target sequence. The model is trained on Multi30K dataset [See: Desmond Elliott, Stella Frank, Khalil Sima'an, and Lucia Specia. 2016. Multi30k: Multilingual englishgerman image descriptions. In Proceedings of the 5th Workshop on Vision and Language, pages 70-74. Association for Computational Linguistics, incorporated herein by reference in its entirety] which is an EnglishGerman image description parallel dataset. The dataset consists of 31.1K samples. 1K of these samples are reserved for testing, and another 1K samples are reserved for validation. The split was provided by Bentrevett [See: Bentrevett. bentrevett/multi30k⋅datasets at hugging face, incorporated herein by reference in its entirety]. The employed architecture is a transformer model consisting of one encoder layer as well as one decoder layer with 8 multi-head attention, 2048 latent dimension, and 256 embedding size. The batch size used is 64. The optimizer used is RMSProb with sparse categorical cross-entropy loss. The model is trained for 10 epochs saving the checkpoint that achieved the lowest validation loss during training. The metric used to analyze the model performance is the 4-gram BLEU score.

In some embodiments, the processor further executes a text retrieval process to reconstruct standard text from the reduced text corpus through multiple processing stages. The retrieval operation implements a specific neural network architecture to predict original vowel placements. The method 100 includes retrieving the plurality of texts from the reduced text corpus based on the neural network model. Herein, the neural network model consists of two layers of bidirectional LSTM each having 512 hidden units and an embedding layer with a dropout of 0.25 to obtain a retrieved text corpus. The processor implements a bidirectional LSTM architecture to analyze both forward and backward context around each mask symbol position. Each LSTM layer contains 512 hidden units to provide sufficient capacity for learning vowel patterns. The embedding layer processes input tokens and applies dropout with 0.25 probability to prevent overfitting. The method further includes performing a post-processing including a spelling correction and a grammar correction to refine the retrieved text corpus. After initial vowel prediction, the processor applies spelling correction algorithms to identify and rectify any incorrectly predicted vowel placements. The spelling correction particularly targets cases involving rare words or proper nouns where vowel prediction may have lower confidence. Grammar correction analyzes sentence structure and word relationships to identify contextually incorrect vowel predictions and apply appropriate corrections based on grammatical rules. The performance of text retrieval from masked-vowel representation can be evaluated using multiple metrics including word error rate (WER), character error rate (CER), and vowels error rate (VER). The VER metric specifically analyzes performance on vowel characters by excluding consonant characters from the error calculation. The processor can implement post-processing steps including spelling correction and grammar correction to refine the retrieved text. In some configurations, the processor also maintains a log of correction patterns to improve future retrieval accuracy.

The retrieval process addresses specific challenges with different text representations. For consonants-only representation, the processor implements additional logic to handle missing vowel-only words such as “a” and “I”. The masked-vowel representation enables more accurate retrieval due to preserved word count and explicit vowel position marking through mask symbols. Error analysis provides that retrieval errors commonly occur with unknown words which are not present in the training corpus and with proper nouns having unusual vowel patterns. The retrieved text undergoes quality validation to ensure maintenance of semantic meaning and grammatical correctness. The processor generates confidence scores for vowel predictions to flag potentially problematic retrievals for manual review when necessary. The retrieval system achieves sufficient accuracy to enable practical deployment of the masked-vowel representation technique in production environments.

Referring now to FIG. 2, illustrated is an exemplary schematic diagram of a system (as represented by reference numeral 200) for performing a plurality of natural language processing tasks in a text corpus having a plurality of texts. In various embodiments, the system 200 implements the method 100 described in the preceding paragraphs. The system 200 achieves the same technical benefits and performance characteristics previously discussed. The components and operations of system 200 correspond to and execute the steps, procedures, and techniques detailed above with respect to method 100. Therefore, the detailed descriptions regarding masked-vowel vocabulary reduction, entropy computation, model training, parameter tuning, and task execution provided above apply mutatis mutandis to implementation of the system 200 and are not repeated here for brevity of the present disclosure.

As illustrated in FIG. 2, the system 200 includes an input device 210, a processor 220 including a graphics processing unit (GPU) 222, and a memory 230. The input device 210 is configured to obtain a user-selected task from the plurality of natural language processing tasks. The input device 210 receives user input specifying whether to execute text classification, sequence labeling, or translation operations on the text corpus. The input device 210 communicates the selected task parameters to the processor 220 for task initialization and execution. The processor 220 includes the GPU 222 and is connected to the input device 210. The processor 220 executes program instructions stored in the memory 230 to perform the natural language processing operations. The GPU 222 provides parallel processing capabilities for executing computationally intensive operations such as model training and task execution. The processor 220 implements the masked-vowel vocabulary reduction on the input text corpus, computes entropy metrics for the reduced texts, and executes model training and tuning operations as detailed previously. The memory 230 is connected to the processor 220 and stores program instructions and data required for system operation. The memory 230 maintains the text corpus, reduced text representations, model parameters, and processing results. The memory 230 stores different versions of the working models optimized for specific tasks and text representation formats. The memory 230 also maintains dictionaries and reference data required for text processing operations.

In operation, when the input device 210 receives a user-selected task, the processor 220 retrieves corresponding program instructions and model parameters from the memory 230. The processor 220 executes masked-vowel vocabulary reduction on the input text corpus to generate reduced text representations. The GPU 222 accelerates computation-intensive operations such as model training. The processor 220 stores intermediate processing results and final outputs in the memory 230. The system 200 maintains separate processing workflows for text classification, sequence labeling, and translation tasks while utilizing shared text reduction and model optimization procedures.

The processor 220 executes masked-vowel vocabulary reducing the plurality of texts in the text corpus based on a masked-vowel representation technique to obtain a reduced text corpus having a plurality of reduced texts, where the mask-vowel technique replaces vowels with predefined mask symbols while preserving word counts. The processor 220 then executes computing an entropy of the reduced texts in the reduced text corpus to evaluate information content and predictability of the reduced representation. The processor 220 proceeds with training a plurality of causal language models including a statistical model, a recurrent neural network (RNN)-based model, and a transformer-based models with a training corpus, where the GPU 222 accelerates the computationally intensive model training operations through parallel processing capabilities. The processor 220 then executes tuning a plurality of model parameters of a working model designated based on a user-selected task of the various types of natural language processing tasks, optimizing model performance for the specific task requirements. The processor 220, finally, executes performing the user-selected task with the working model, generating task-specific outputs that are stored in the memory 230. The system 200 maintains separation between text processing, model training, and task execution workflows while enabling efficient resource utilization through the GPU 222 acceleration and optimized memory 230 access patterns.

In certain embodiments of the system 200, the plurality of natural language processing tasks is selected from the group consisting of a text classification task, a sequence labeling task, and a translation task. The input device 210 presents the task options to users and receives their selection, communicating the chosen task type to the processor 220. For text classification tasks, the system 200 configures processing workflows for both binary and multiclass classification operations. For sequence labeling tasks, the system 200 establishes token processing pipelines that maintain sequence length preservation between inputs and outputs. For translation tasks, the system 200 implements bidirectional translation workflows between specified language pairs. The memory 230 maintains separate storage areas for task-specific model parameters, processing states, and output formats. The processor 220 and GPU 222 adjust resource allocation and processing patterns based on the computational requirements of each task type, with sequence labeling and translation typically requiring more intensive processing compared to classification tasks.

In particular embodiments, the statistical model is a n-gram language model. Herein, the n-gram language model is selected from the group consisting of 2-gram language model, 3-gram language model, 4-gram language model, 5-gram language model, and 6-gram language model. The processor 220 implements distinct processing workflows for each n-gram configuration, with the memory 230 maintaining separate parameter sets for different n-gram lengths. The GPU 222 accelerates n-gram sequence processing through parallel computation of token patterns. The system 200 loads appropriate n-gram model configurations from memory 230 based on task requirements and performance targets. For lower n-gram values (2-gram, 3-gram), the system 200 implements more efficient memory access patterns due to shorter sequence lengths. For higher n-gram values (4-gram through 6-gram), the system 200 utilizes more extensive GPU 222 resources to handle longer sequence dependencies. The processor 220 monitors relative performance across different n-gram configurations to identify optimal sequence lengths for specific tasks and text representations.

In an embodiment, the working model is an RNN model when the user-selected task is the text classification task. Herein, the text classification task comprises a binary sentiment analysis and a multiclass text classification, and wherein the performing the user-selected task further includes categorizing the reduced texts into subcategories. The system 200 configures the RNN model parameters in memory 230 for classification operations when the input device 210 receives a text classification task selection. For binary sentiment analysis, the system 200 establishes dual-category classification workflows, while multiclass classification utilizes expanded category mapping structures. The processor 220 and GPU 222 execute parallel processing of n-gram sequences across multiple texts to accelerate classification operations. The memory 230 maintains separate storage sections for positive/negative sentiment categories in binary classification and multiple news categories in multiclass classification.

In an embodiment, the working model is the RNN-based model when the user-selected task is the sequence labeling task. Herein, the performing the user-selected task further comprises assigning a label to a sequence of tokens in the reduced texts corpus to obtain a labeled sequence of tokens. The system 200 loads RNN-based model configurations from memory 230 when the input device 210 receives a sequence labeling task selection. The processor 220 establishes bidirectional processing pipelines for analyzing token sequences, with the GPU 222 accelerating matrix operations for the LSTM layers. The memory 230 maintains label mappings for both part-of-speech tags and named entity categories, enabling efficient label assignment during processing. The system 200 implements sequence length preservation mechanisms to maintain one-to-one correspondence between input tokens and output labels.

In an embodiment, the working model is the transformer-based model when the user-selected task is the translation task. Herein, the performing the user-selected task further comprises tokenizing each reduced text of the plurality of reduced texts in the reduced texts corpus and translating the reduced texts in the reduced texts corpus in a first language to a second language to obtain a translated texts corpus. The system 200 activates transformer model configurations in memory 230 when the input device 210 receives a translation task selection. The processor 220 implements separate processing stages for tokenization and translation, with the GPU 222 accelerating attention mechanism computations. The memory 230 maintains language-specific token vocabularies and translation parameters for both languages; e.g., English-to-German and German-to-English operations. The system 200 processes translation tasks in configurable batch sizes to optimize GPU 222 utilization while managing memory 230 constraints.

In particular embodiments of the system 200, the mask-vowel representation technique comprises parsing the plurality of texts in the text corpus to identify one or more vowels in the plurality of texts, and replacing the one or more vowels with a mask-symbol. Herein, the mask-symbol corresponds to each vowel of the one or more vowels. Further, a total number of each word in the plurality of texts is preserved. The processor 220 implements the parsing operation by scanning input texts in configurable chunk sizes to identify vowel positions. The memory 230 maintains character mapping tables for vowel identification and mask symbol substitution operations. The system 200 implements word count preservation mechanisms that track and validate token counts before and after vowel masking. The GPU 222 accelerates text parsing operations through parallel processing of multiple text segments, while the processor 220 manages sequential aspects of mask symbol replacement to maintain text integrity. In an embodiment, the mask-symbol is a single character including a “#”. The system 200 maintains consistent mask symbol implementation across all processing stages by storing mask symbol configuration in dedicated memory 230 locations.

In some embodiments, the system 200 further comprises retrieving the texts from the reduced text corpus based on the RNN model. Herein, the n-gram language model consists of two layers of bidirectional LSTM each having 512 hidden units and an embedding layer with a dropout of 0.25 to obtain a retrieved text corpus. The system 200 further comprises performing a post-processing including a spelling correction and a grammar correction to refine the retrieved text corpus. The processor 220 implements a two-stage restoration process where the GPU 222 accelerates LSTM computations for initial vowel prediction, followed by sequential post-processing operations. The memory 230 maintains reference dictionaries and grammar rules for post-processing refinement. The system 200 implements separate workflows for consonants-only and masked-vowel text restoration, with specific handling for vowel-only words in consonants-only representation. The processor 220 manages error tracking and correction pattern logging to improve future restoration accuracy through adaptive refinement of post-processing rules.

The following description discusses test data and results of performing natural language processing tasks in a text corpus, using the method 100 or the system 200 of the present disclosure. Herein, text analysis is performed on the text corpora to evaluate the effectiveness of the masked-vowel vocabulary reduction technique. Table 1 (below) presents a summary of the vocabulary and token statistics at the word level for all the datasets (training sets) used in the experiments for the three text representations. Herein, for Multi30K, the English portion of the dataset is only considered. It is to be noted that from hereon, S represents the standard text, C represents consonants-only, and M represents masked-vowel representations. Analysis of vocabulary and token statistics at word level across multiple datasets demonstrated that consonants-only representation achieved vocabulary size reduction of at least 15% on training sets, with an average reduction of 18%. The reduction ratio increased with dataset size, reaching approximately 23% for the Wikitext dataset [See: Stephen et al.]. The masked-vowel representation showed similar but less significant reduction, with maximum reduction of approximately 10% and average reduction of 7%.

TABLE 1
Summary of the vocabulary and token statistics (at word level)
comparing the proposed representations with the standard text.

| | Vocabulary size \|V\| | | | | | Tokens (N) | | |
|---|---|---|---|---|---|---|---|---|
| Text Corpora | V_{S} | V_{C} | V_{M} | V_{C}/V_{S} | V_{M}/V_{S} | N_{S} | N_{C} | N_{C}/N_{S} |
| Wikitext | 33,277 | 25,538 | 30,090 | 0.77 | 0.90 | 2,265,796 | 2,221,913 | 0.98 |
| IMDB | 280,617 | 231,543 | 260,846 | 0.83 | 0.93 | 5,844,680 | 5,613,725 | 0.96 |
| AGNews | 188,110 | 154,700 | 173,749 | 0.82 | 0.92 | 4,541,694 | 4,430,395 | 0.98 |
| EWT | 32,273 | 27,305 | 30,376 | 0.85 | 0.94 | 199,040 | 191,482 | 0.96 |
| CoNLLpp | 26,883 | 22,420 | 25,250 | 0.83 | 0.94 | 254,983 | 250,387 | 0.98 |
| Multi30k | 15,456 | 12,844 | 14,394 | 0.83 | 0.93 | 345,020 | 295,833 | 0.86 |

Token size analysis revealed that consonants-only representation experienced approximately 4% decrease due to omission of vowels-only words, with exception of Multi30K dataset [See: Elliott et al.] which showed larger reduction due to extensive use of determiner “a”. The Wikitext dataset showed smallest decrease in token size at 2% reduction, attributed to presence of non-English characters and punctuation marks which were intentionally preserved to maintain real-world language usage characteristics.

Entropy analysis is performed at both word and character levels. Table 2 (below) presents the entropy of the text at the word and character levels. Herein, H_{wd} and H_{ch} are the entropy at word and character levels, respectively. At word level, consonants-only representation demonstrates lowest entropy except for Multi30K dataset, followed by masked-vowel representation and standard English text, correlating with vocabulary sizes of respective representations. Character-level entropy shows different patterns, with masked-vowel representation exhibiting lowest entropy among all three representations. This is attributed to predictable patterns of consonants typically being followed by one or two masked vowels within words. Consonants-only representation maintains character entropy close to standard English text despite removal of five vowels (19% of character set), noting that vowels comprised approximately 38% of text in analyzed datasets.

TABLE 2
Text entropy at word and character levels
on the training split of each dataset.

| | S | C | M | S | C | M |
|---|---|---|---|---|---|---|
| Wikitext | 10.2 | 9.8 | 10 | 4.8 | 4.7 | 4 |
| IMDB | 11.2 | 10.8 | 11 | 4.7 | 4.5 | 3.8 |
| AGNews | 12.1 | 11.6 | 11.8 | 4.9 | 4.7 | 4 |
| EWT | 11.1 | 10.6 | 10.8 | 4.8 | 4.6 | 3.9 |
| CoNLLpp | 10.8 | 10.4 | 10.7 | 5 | 4.9 | 4.2 |
| Multi30k | 8.9 | 9 | 8.5 | 4.4 | 4.1 | 3.5 |

Language modeling tests demonstrated distinct performance patterns across different model architectures. Table 3 (below) presents the perplexity results for the language modeling (LM) tasks. For n-gram language models, testing revealed standard text exhibited highest perplexity, followed by masked-vowel representation, and consonants-only representation showing lowest perplexity. This pattern remains consistent across all n-gram configurations from 2-gram through 6-gram implementations. The correlation between perplexity scores and vocabulary sizes is observed across all representations. Further, Table 4 (below) presents the results for RNN-based and Transformer-based models. The recurrent neural network (RNN)-based language models demonstrates significantly lower perplexity scores compared to n-gram models, with minimal variation between representations. The slightly higher perplexity in consonants-only representation is attributed to absence of vowel-only words like “a” and “I”, affecting next-word prediction accuracy. Transformer-based model testing demonstrates lowest perplexity for standard text representation, though differences between representations are minimal. Perplexity scores of 94.90, 94.60, and 95.79 are recorded for standard, consonants-only, and masked-vowel representations respectively. Implementation of subword tokenization yielded vocabulary sizes of 20,110, 13,041, and 17,247 for standard-text, consonants-only, and masked-vowel representations respectively. RNN-based and transformer-based models maintained consistent performance patterns across different tokenization approaches.

TABLE 3
Perplexity results from statistical n-grams and neural
language models on the test set of Wikitext dataset.

| | Perplexity (PPL) | | |
|---|---|---|---|
| Model | S | C | M |
| 2-gram | 515.89 | 451.74 | 481.18 |
| 3-gram | 444.02 | 388.08 | 411.84 |
| 4-gram | 434.92 | 379.16 | 402.76 |
| 5-gram | 433.22 | 377.49 | 401.01 |
| 6-gram | 432.90 | 377.21 | 400.73 |
| RNN LM | 102.47 | 106.83 | 100.29 |
| Transformer LM | 94.90 | 94.60 | 95.79 |

TABLE 4
Language models perplexity results on subwords tokenization

| | Perplexity (PPL) | | |
|---|---|---|---|
| Model | S | C | M |
| RNN LM | 8.33 | 8.20 | 8.17 |
| Transformer LM | 7.52 | 7.50 | 7.52 |

Natural language processing task evaluation demonstrates competitive performance of reduced text representations. Table 5 (below) presents an overview of the results obtained from sentiment analysis on the IMDB dataset and multiclass text classification on the AGNews dataset. Testing demonstrates the n-gram model achieves classification accuracy of 83.68% for consonants-only and 84.68% for masked-vowel representations on the binary sentiment analysis task, compared to 85.17% for standard text.

TABLE 5
A summary of the text classification results
using the three representations.

| | Accuracy | | |
|---|---|---|---|
| Dataset | S | C | M |
| IMDB | 85.17 | 83.68 | 84.68 |
| AGNews | 91.70 | 91.80 | 91.67 |

Sequence labeling task evaluation includes part-of-speech (POS) tagging and named entity recognition (NER). Table 6 presents results of POS tagging and NER using the English Web Treebank (EWT) and CoNLLpp datasets, respectively. POS tagging tests shows consonants-only representation experienced significant performance decrease of over 4% compared to standard text representation, while masked-vowel representation maintains comparable performance. Analysis using a confusion matrix reveals that performance drop is primarily due to absence of words like “a” and “I” in consonants-only representation, which constitute significant token count and are typically easily classified as determiner and pronoun respectively.

TABLE 6
Summary of the results on the sequence labeling tasks.

| | Accuracy | | |
|---|---|---|---|
| Task (Dataset) | S | C | M |
| POS Tagging (EWT) | 91.44 | 87.26 | 91.16 |
| NER (CoNLLpp) | 93.97 | 93.88 | 94.54 |

NER testing demonstrate competitive performance compared to standard English text, with masked-vowel representation outperforming standard text by reducing absolute error by over 0.5%, while consonants-only representation maintains comparable performance. Table 7 (below) presents translation results for English-to-German (en-de) and German-to-English (de-en) tasks. Translation task evaluation showed comparable results across representations for English-to-German translation. German-to-English translation show notable performance drop in consonants-only approach. This lower performance of consonants-only representation in German-to-English translation is attributed to the absence of vowel-only words like “a” in the reduced text format. Masked-vowel representation demonstrated superior performance compared to standard English representation, noting that model is optimally calibrated for standard English representation.

TABLE 7
Translation results in BLEU score

| | BLEU | | |
|---|---|---|---|
| Task | S | C | M |
| English-to-German | 30.56 | 29.70 | 28.19 |
| German-to-English | 29.70 | 25.19 | 29.80 |

Standard text retrieval testing is performed using AGnews dataset for training and evaluation. Table 8 (below) presents retrieval results from proposed representations, measured using word-error-rate (WER), character error-rate (CER), and vowels-error-rate (VER). Masked-vowel representation demonstrated superior retrieval performance compared to consonants-only representation. To evaluate the model performance while disregarding words that consist solely of vowels, the aforementioned metrics are calculated after removing these tokens from both the predicted output and the original text. The resulting metrics are as follows: 6.4% for word-error-rate, 3.15% for character-error-rate, and 3.85% for vowels-error rate. The approximately 3% difference in word error-rate aligns with the reported ratio of consonant tokens to standard text tokens presented in Table 1 for the AGNews dataset. Error analysis reveals retrieval errors in masked-vowel representation as well as consonants-only representation.

For masked-vowels representation, some errors occur due to the presence of unknown words, like words in the test set that are not present in the training set. Since the model is not exposed to these words during training, it struggles to accurately retrieve the vowels. Additionally, it is noticed that a significant portion of the errors stem from nouns. These nouns may be relatively rare in the training set, resulting in lower model familiarity and increased difficulty in predicting the correct vowels for these words. In the consonants-only representation, additional sources of errors are observed in vowel retrieval. These include errors related to abbreviations and cases of letters, as well as challenges in capturing vowel positions within words.

TABLE 8
Standard text retrieval results. WER is the word-error-rate, CER
is the character-error-rate, and VER is the vowel-error-rate.

| | WER | CER | VER |
|---|---|---|---|
| Consonants | 8.99 | 4.06 | 5.60 |
| Masked-Vowels | 2.87 | 1.78 | 1.87 |

Further comparative analysis examines model sizes across different representations. Table 9 (below) presents model sizes for different datasets across disclosed representations compared to standard English text. The table illustrated that the model size is closely related to the vocabulary size, as the embedding layers have a dominant effect on the model size. For example, the language models have sizes of 101 MB, 86 MB, and 95 MB respectively for the standard English, consonants-only, and masked vowels representations. Additionally, the model size on storage devices is also influenced by its total number of parameters. Moreover, a lower model size indicates a lower training time per epoch. In the language model experiment, for example, the training time per epoch is 82.14 seconds for the standard text, 67.55 seconds for the consonants-only representation, and 77.07 seconds for the masked-vowels representation. Thus, the reduced model size contributed to faster training.

Another aspect of comparison is the Out-Of Vocabulary (OOV) rate and unknown tokens. In some tasks, it is common to remove words with a single occurrence to reduce model size and avoid overfitting. In the AGNews dataset, the number of single-occurrence vocabularies is 27,348 out of 79,037 for the standard text representation. For the consonants-only representation, the number of these vocabularies is 17,283 out of 54,596, and for the masked-vowels representation, it is 22,660 out of 67,982. Accordingly, the ratio of these unknown vocabularies is 34.60%, 31.66%, and 33.33% for the standard text, consonants-only representation, and masked-vowels representation, respectively.

TABLE 9
Models sizes for differed text representations in terms
in the number of parameters (in Millions). For Multi30K,
the reported results were for de-en experiment.

| | Number of parameters (M) | | |
|---|---|---|---|
| Dataset | S | C | M |
| Wikitext | 25.5 | 21.5 | 23.8 |
| IMDB | 32.5 | 25.2 | 29.3 |
| AGNews | 32.8 | 25.4 | 29.5 |
| EWT | 16.4 | 14.3 | 15.6 |
| ConLLpp | 18.4 | 16.4 | 17.7 |
| Multi30K | 16.2 | 15.0 | 15.7 |

Comparative analysis of model parameters demonstrated consistent size reduction across datasets. Model size reduction directly impacts computational resource requirements, with reduced vocabulary sizes enabling faster training and inference operations. Storage requirements show corresponding reductions, with model parameter counts decreasing proportionally to vocabulary size reduction. Training time improvements demonstrate practical efficiency gains, with reduced text representations enabling faster model convergence while maintaining comparable task performance across tested natural language processing applications.

The present disclosure provides novel text representation techniques by implementing masked-vowel vocabulary reduction and consonants-only representation for natural language processing tasks. The masked-vowel representation technique preserves word count and structure while reducing vocabulary size through consistent vowel masking using a single mask symbol. The method 100 and the system 200 of the present disclosure for performing natural language processing tasks demonstrates effective processing across text classification tasks, sequence labeling tasks, and translation tasks through coordinated implementation of statistical models, recurrent neural network (RNN)-based models, and transformer-based models operating on reduced text representations.

The method 100 and the system 200 of the present disclosure achieve technical advantages over conventional text processing approaches through reduced computational requirements and efficient resource utilization. The masked-vowel vocabulary reduction maintains sequence integrity while enabling smaller model architectures and reduced embedding layer sizes. The consonants-only representation achieves substantial vocabulary reduction while preserving essential linguistic information, enabling decreased model parameters and memory requirements. The method 100 and the system 200 results in executing natural language processing operations with reduced computational overhead while maintaining task performance through optimized text representations.

The method 100 and the system 200 of the present disclosure demonstrate effective task performance across multiple processing categories while requiring fewer computational resources. For text classification tasks, the masked-vowel representation maintains competitive classification accuracy while enabling smaller model architectures. For sequence labeling tasks, the token-level accuracy is preserved while processing reduced vocabulary sets. The translation task implementation maintains translation quality while achieving improved processing efficiency through reduced vocabulary handling. The present disclosure further enables retrieval of standard text through implementation of bidirectional long short-term memory (LSTM) neural networks, with post-processing operations including spelling correction and grammar correction refining the retrieved text output. The reduced text representations enable practical deployment of natural language processing capabilities with decreased computational and storage requirements.

Next, further details of the hardware description of a computing environment according to exemplary embodiments is described with reference to FIG. 3. In FIG. 3, a controller 300 is described, in which the controller 300 is representative of the processor 220 of the system 200 (as also implemented in the method 100) which includes a CPU 301 which performs the processes described above/below. The process data and instructions may be stored in memory 302. These processes and instructions may also be stored on a storage medium disk 304 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 301, 303 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 301 or CPU 303 may be a Xenon or Core processor from Intel of America or an Opteron processor from AMD of America, or may be other processor types that would be recognized by one of ordinary skill in the art. Alternatively, the CPU 301, 303 may be implemented on an FPGA, ASIC, PLD or using discrete logic circuits, as one of ordinary skill in the art would recognize. Further, CPU 301, 303 may be implemented as multiple processors cooperatively working in parallel to perform the instructions of the inventive processes described above.

The computing device in FIG. 3 also includes a network controller 306, such as an Intel Ethernet PRO network interface card from Intel Corporation of America, for interfacing with network 360. As can be appreciated, the network 360 can be a public network, such as the Internet, or a private network such as an LAN or WAN network, or any combination thereof and can also include PSTN or ISDN sub-networks. The network 360 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 308, such as a NVIDIA GeForce GTX or Quadro graphics adaptor from NVIDIA Corporation of America for interfacing with display 310, such as a Hewlett Packard HPL2445w LCD monitor. A general purpose I/O interface 312 interfaces with a keyboard and/or mouse 314 as well as a touch screen panel 316 on or separate from display 310. General purpose I/O interface also connects to a variety of peripherals 318 including printers and scanners, such as an OfficeJet or DeskJet from Hewlett Packard.

A sound controller 320 is also provided in the computing device such as Sound Blaster X-Fi Titanium from Creative, to interface with speakers/microphone 322 thereby providing sounds and/or music.

The general purpose storage controller 324 connects the storage medium disk 304 with communication bus 326, which may be an ISA, EISA, VESA, PCI, or similar, for interconnecting all of the components of the computing device. A description of the general features and functionality of the display 310, keyboard and/or mouse 314, as well as the display controller 308, storage controller 324, network controller 306, sound controller 320, and general purpose I/O interface 312 is omitted herein for brevity as these features are known.

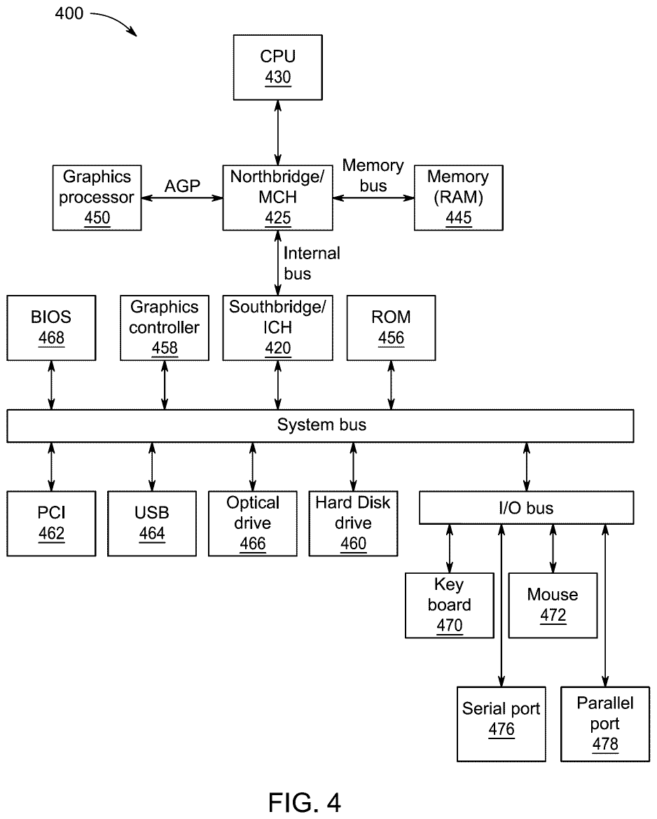

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 4.

FIG. 4 shows a schematic diagram of a data processing system, according to certain embodiments, for performing the functions of the exemplary embodiments. The data processing system is an example of a computer in which code or instructions implementing the processes of the illustrative embodiments may be located.

In FIG. 4, data processing system 400 employs a hub architecture including a north bridge and memory controller hub (NB/MCH) 425 and a south bridge and input/output (I/O) controller hub (SB/ICH) 420. The central processing unit (CPU) 430 is connected to NB/MCH 425. The NB/MCH 425 also connects to the memory 55 via a memory bus, and connects to the graphics processor 60 via an accelerated graphics port (AGP). The NB/MCH 425 also connects to the SB/ICH 420 via an internal bus (e.g., a unified media interface or a direct media interface). The CPU Processing unit 430 may contain one or more processors and even may be implemented using one or more heterogeneous processor systems.

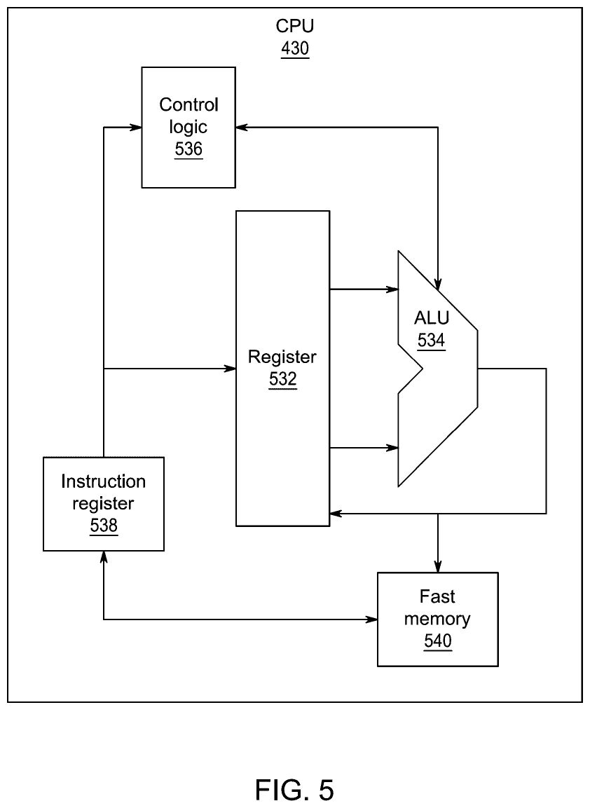

For example, FIG. 5 shows one implementation of CPU 430. In one implementation, the instruction register 538 retrieves instructions from the fast memory 540. At least part of these instructions are fetched from the instruction register 538 by the control logic 536 and interpreted according to the instruction set architecture of the CPU 430. Part of the instructions can also be directed to the register 532. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 534 that loads values from the register 532 and performs logical and mathematical operations on the loaded values according to the instructions. The results from these operations can be feedback into the register and/or stored in the fast memory 540. According to certain implementations, the instruction set architecture of the CPU 430 can use a reduced instruction set architecture, a complex instruction set architecture, a vector processor architecture, a very large instruction word architecture. Furthermore, the CPU 430 can be based on the Von Neuman model or the Harvard model. The CPU 430 can be a digital signal processor, an FPGA, an ASIC, a PLA, a PLD, or a CPLD. Further, the CPU 430 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 4, the data processing system 400 can include that the SB/ICH 420 is coupled through a system bus to an I/O Bus, a read only memory (ROM) 66, universal serial bus (USB) port 464, a flash binary input/output system (BIOS) 468, and a graphics controller 68. PCI/PCIe devices can also be coupled to SB/ICH 488 through a PCI bus 462.

The PCI devices may include, for example, Ethernet adapters, add-in cards, and PC cards for notebook computers. The Hard disk drive 460 and CD-ROM 466 can use, for example, an integrated drive electronics (IDE) or serial advanced technology attachment (SATA) interface. In one implementation the I/O bus can include a super I/O (SIO) device.

Further, the hard disk drive (HDD) 460 and optical drive 466 can also be coupled to the SB/ICH 420 through a system bus. In one implementation, a keyboard 470, a mouse 472, a parallel port 478, and a serial port 476 can be connected to the system bus through the I/O bus. Other peripherals and devices that can be connected to the SB/ICH 420 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

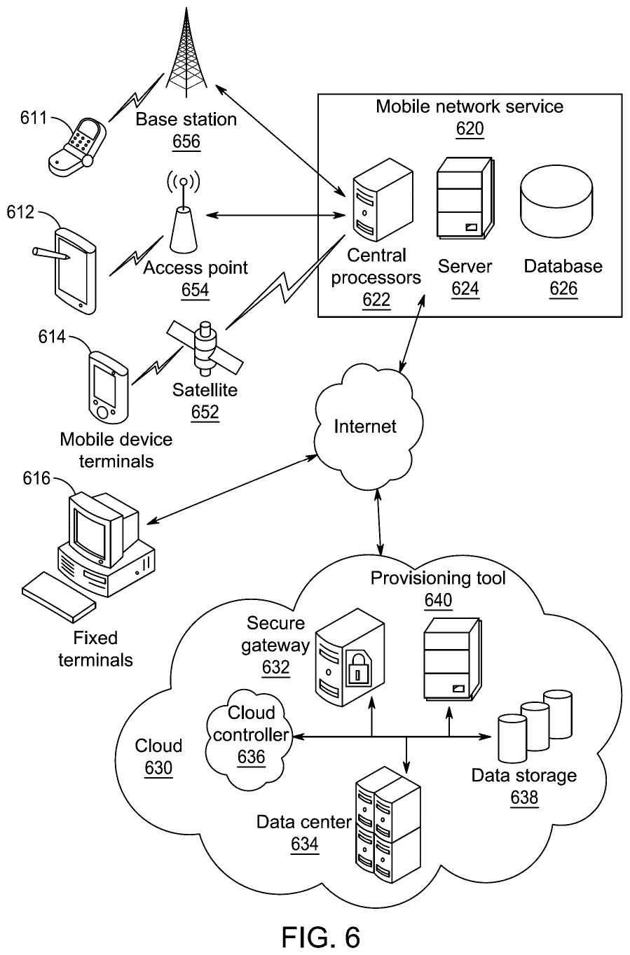

The functions and features described herein may also be executed by various distributed components of a system. For example, one or more processors may execute these system functions, wherein the processors are distributed across multiple components communicating in a network. The distributed components may include one or more client and server machines, such as cloud 630 including a cloud controller 636, a secure gateway 632, a data center 634, data storage 638 and a provisioning tool 640, and mobile network services 620 including central processors 622, a server 624 and a database 626, which may share processing, as shown by FIG. 6, in addition to various human interface and communication devices (e.g., display monitors 616, smart phones 610, tablets 612, personal digital assistants (PDAs) 614). The network may be a private network, such as a LAN, satellite 652 or WAN 654, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

While specific embodiments of the invention have been described, it should be understood that various modifications and alternatives may be implemented without departing from the spirit and scope of the invention. For example, different cellular automata rules or encryption algorithms could be employed, or alternative feature extraction and face recognition techniques could be integrated into the system.

The above-described hardware description is a non-limiting example of corresponding structure for performing the functionality described herein.

Numerous modifications and variations of the present disclosure are possible in light of the above teachings. It is therefore to be understood that the invention may be practiced otherwise than as specifically described herein.

1. A computer-implemented method of performing natural language processing in a text corpus, comprising:
receiving, by a processor, a block of words in the text corpus;
removing all vowels from the block of words with the processor to obtain a reduced text corpus having a reduced vocabulary;
training a plurality of causal language models including a statistical model, a recurrent neural network (RNN)-based model, and a transformer-based model with a training portion of the reduced text corpus to obtain a plurality of respective working causal language models;
receiving, by the processor, a plurality of task-specific language data in the text corpus;
removing all vowels from each of the task-specific language data with the processor to obtain respective reduced task-specific language data;
training a plurality of natural language processing task models with the respective task data to obtain a plurality of working natural language processing task models;
selecting causal language modeling or a natural language processing task, each having a respective one of the plurality of the working causal language models or the plurality of working natural language processing task models; and
performing the selected causal language modeling or the selected natural language processing task using the respective working causal language model or working natural language processing task model with the processor.

2. The method of claim 1, wherein the plurality of natural language processing tasks is selected from the group consisting of a text classification task, a sequence labeling task, and a translation task.

3. The method of claim 1, wherein the statistical model is a n-gram language model, wherein the n-gram language model is selected from the group consisting of 2-gram language model, 3-gram language model, 4-gram language model, 5-gram language model, and 6-gram language model.

4. The method of claim 2, wherein the working natural language processing task model is a RNN-based model when the selected task is the text classification task,
wherein the text classification task comprises a binary sentiment analysis, and
wherein the performing the selected task further comprises categorizing the block of words into one of two subcategories.

5. The method of claim 2, wherein the working natural language processing task model is a RNN-based model when the selected task is the sequence labeling task, and
wherein the performing the selected task further comprises assigning a label to a sequence of tokens in the block of words to obtain a labeled sequence of tokens.

6. The method of claim 2, wherein the working natural language processing task model is a transformer-based model when the selected task is the translation task, and
wherein the performing the selected task further comprises:
tokenizing each reduced text in the reduced texts corpus; and
translating the reduced texts corpus in a first language to a second language to obtain a translated texts corpus.

7. The method of claim 1, wherein the removing all vowels from the block of words comprises:
parsing the block of words in the text corpus to identify one or more vowels in the block of words; and
replacing the one or more vowels with a mask-symbol, wherein the mask-symbol corresponds to each vowel of the one or more vowels.
wherein a total number of each word in the block of words is preserved.

8. The method of claim 7, wherein the step of removing all vowels includes replacing each vowel with the mask-symbol that is a single character including a “#”.

9. The method of claim 1, further comprising:
retrieving the block of words from the reduced text corpus using the RNN language model, wherein the RNN language model consists of two layers of bidirectional LSTM each having 512 hidden units and an embedding layer with a dropout of 0.25 to obtain a retrieved text corpus; and
performing a post-processing including a spelling correction and a grammar correction to refine the retrieved text corpus.

10. A system for performing natural language processing in a text corpus, comprising:
an input device configured to obtain a user-selected causal language modeling or a natural language processing task;
a processor comprising a graphics processing unit (GPU) and connected to the input device; and
a memory connected to the processor;
wherein the processor is configured to execute program instructions, comprising:
vowel vocabulary reducing in a text corpus by removing all vowels from a block of words in the text corpus to obtain a reduced text corpus having a reduced vocabulary;
training a plurality of causal language models including a statistical model, a recurrent neural network (RNN)-based model, and a transformer-based models with a training portion of the reduced text corpus to obtain a plurality of respective working causal language models;
receiving a plurality of task-specific language data in the text corpus corresponding to a plurality of natural language processing tasks;
removing all vowels from each of the task-specific language data to obtain respective reduced task-specific language data;
training a plurality of natural language processing task models with the respective task data to obtain a plurality of working natural language processing task models;
selecting one of the plurality of working causal language models or the plurality of working natural language processing task models based on the user-selected natural language processing task; and
performing the user-selected task using the selected causal language modeling or the selected natural language processing task using the respective working causal language model or working natural language processing task model.

11. The system of claim 10, wherein the plurality of natural language processing tasks is selected from the group consisting of a language modeling task, a text classification task, a sequence labeling task, and a translation task.

12. The system of claim 10, wherein the statistical model is a n-gram language model, wherein the n-gram language model is selected from the group consisting of 2-gram language model, 3-gram language model, 4-gram language model, 5-gram language model, and 6-gram language model.

13. The system of claim 11, wherein the working natural language processing task model is a RNN-based model when the user-selected task is the text classification task,
wherein the text classification task comprises a binary sentiment analysis, and
wherein the performing the user-selected task further comprises categorizing the block of words into one of two subcategories.

14. The system of claim 11, wherein the working natural language processing task model is a RNN-based model when the user-selected task is the sequence labeling task, and
wherein the performing the user-selected task further comprises assigning a label to a sequence of tokens in the block of words to obtain a labeled sequence of tokens.

15. The system of claim 12, wherein the working natural language processing task model is a transformer-based model when the user-selected task is the translation task, and
wherein the performing the user-selected task further comprises:
tokenizing each reduced text in the reduced texts corpus; and
translating the reduced texts corpus in a first language to a second language to obtain a translated texts corpus.

16. The system of claim 10, wherein the removing all vowels from the block of words comprises:
parsing the block of words in the text corpus to identify one or more vowels in the block of words; and
replacing the one or more vowels with a mask-symbol, wherein the mask-symbol corresponds to each vowel of the one or more vowels.
wherein a total number of each word in the block of words is preserved.

17. The system of claim 16, wherein the mask-symbol is a single character including a “#”.

18. The system of claim 10, further comprising:
retrieving the block of words from the reduced text corpus using the RNN language model, wherein the RNN model consists of two layers of bidirectional LSTM each having 512 hidden units and an embedding layer with a dropout of 0.25 to obtain a retrieved text corpus; and
performing a post-processing including a spelling correction and a grammar correction to refine the retrieved text corpus.
